(19) United States
(12) Patent Application Publication
(10) Pub. No.: US 2015/0310442 A1
(43) Pub. Date: Oct. 29, 2015

(54) METHODS, SYSTEMS AND COMPUTER READABLE MEDIA FOR DETERMINING CRIMINAL PROPENSITIES IN A GEOGRAPHIC LOCATION BASED ON PURCHASE CARD TRANSACTION DATA

(71) Applicant: MasterCard International Incorporated, Purchase, NY (US)

(72) Inventor: Edward M. Lee, Scarsdale, NY (US)

(73) Assignee: MASTERCARD INTERNATIONAL INCORPORATED, Purchase, NY (US)

(21) Appl. No.: 14/262,583

(22) Filed: Apr. 25, 2014

(51) Int. Cl. G06Q 20/40; G06Q 20/34; H04L 29/08

(52) U.S. Cl. CPC G06Q 20/4016; H04L 67/18; G06Q 20/34

(57) ABSTRACT

Methods, systems, and computer readable media for determining criminal propensities in a geographic location based on customer card transaction data are disclosed. In one example, the method includes utilizing purchase card transaction data associated with purchase card transactions conducted during a designated time period to determine a plurality of first normalized regional expenditure indices corresponding to a plurality of industry categories for a first geographic location. The method further includes generating an algorithmic model based on correlations between each of the first normalized regional expenditure indices and a plurality of criminal offense types committed during the designated time period and applying the algorithmic model to each of a plurality of second normalized regional expenditure indices corresponding to the plurality of industry categories associated with a second geographic location in order to determine a criminal propensity indicator in the second geographic location for each of the plurality of criminal offense types.

### TECHNICAL FIELD

The subject matter described herein relates to the use of purchase card transaction information to generate a model for predicting the likelihood of criminal activity in a geographic region or area. More particularly, the subject matter described herein relates to systems, methods, and computer readable media for determining criminal propensities in a geographic location based on purchase card transaction data.

### BACKGROUND

It is generally known that criminal activity committed in a particular geographic location can be directly correlated to the socioeconomics associated with said geographic location. Although this correlation does not imply causality, the consideration of the socioeconomic environment of a particular geographic location could be helpful to determine if that region or area may be more prone to the commission of certain unlawful activities. Such a determination may prove beneficial in geographic locations where the access to criminal activity data is sparse and/or where resources dedicated to local law enforcement agencies may be limited. Notably, there is at present no means for effectively predicting the likelihood of criminal activity in these geographic locations or areas.

Accordingly, there exists a need for improved systems, methods, and computer readable media for determining criminal propensities in a geographic location based on purchase card transaction data.

### SUMMARY

According to one aspect, the subject matter described herein relates to, methods, systems, and computer readable media for determining criminal propensities in a geographic location based on customer card transaction data. In one embodiment, the method utilizing purchase card transaction data associated with purchase card transactions conducted during a designated time period to determine a plurality of first normalized regional expenditure indices corresponding to a plurality of industry categories for a first geographic location. The method further includes generating an algorithmic model based on correlations between each of the first normalized regional expenditure indices and a plurality of criminal offense types committed during the designated time period and applying the algorithmic model to each of a plurality of second normalized regional expenditure indices corresponding to the plurality of industry categories associated with a second geographic location in order to determine a criminal propensity indicator in the second geographic location for each of the plurality of criminal offense types.

The subject matter described herein may be implemented in hardware, software, firmware, or any combination thereof. As such, the terms “function”, “node”, “unit”, or “module” as used herein refer to hardware, which may also include software and/or firmware components, for implementing the feature being described. In one exemplary implementation, the subject matter described herein may be implemented using a non-transitory computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

Preferred embodiments of the subject matter described herein will now be explained with reference to the accompanying drawings, wherein like reference numerals represent like parts, of which:

FIG. 1 is a block diagram illustrating an exemplary system for determining criminal propensities in a geographic location based on purchase card transaction data according to an embodiment of the subject matter described herein;

FIG. 2 is a block diagram illustrating an exemplary processing server for determining criminal propensities in a geographic location based on purchase card transaction data according to an embodiment of the subject matter described herein; and

FIG. 3 is a flow chart illustrating an exemplary process for determining criminal propensities in a geographic location based on purchase card transaction data according to an embodiment of the subject matter described herein.

### DETAILED DESCRIPTION

In accordance with the subject matter disclosed herein, methods, systems, and computer readable media for determining criminal propensities in a geographic location based on purchase card transaction data are disclosed. As used herein, purchase card transaction data may include consumer card transaction data (e.g., credit card transaction data and prepaid card transaction data), debit card transaction data, corporate card transaction data, loyalty card transaction data, and the like. The present subject matter provides a modeling approach that utilizes purchase card transaction data to create an algorithmic model that may be used to predict the likelihood of criminal activity in a certain geographic location, region, or area. Specifically, the algorithmic model may be utilized to identify propensities for various criminal offenses in a location where purchase card transaction data is readily accessible but the availability of criminal activity data may be sparse. Thus, the modeling described by the disclosed subject matter is based on the notion that purchase card transaction data (e.g., electronic purchase card transaction data associated with the use of a credit card, a debit card, a prepaid card, a loyalty card, a corporate card, and the like) may be utilized to generate an algorithmic model that is capable of determining criminal propensities in a particular geographic location (e.g., a state, county, city, zip code, police precinct, area code, etc.). Such a tool may effectively enable law enforcement agencies to properly allocated manpower and other limited resources to certain identified geographical locations.

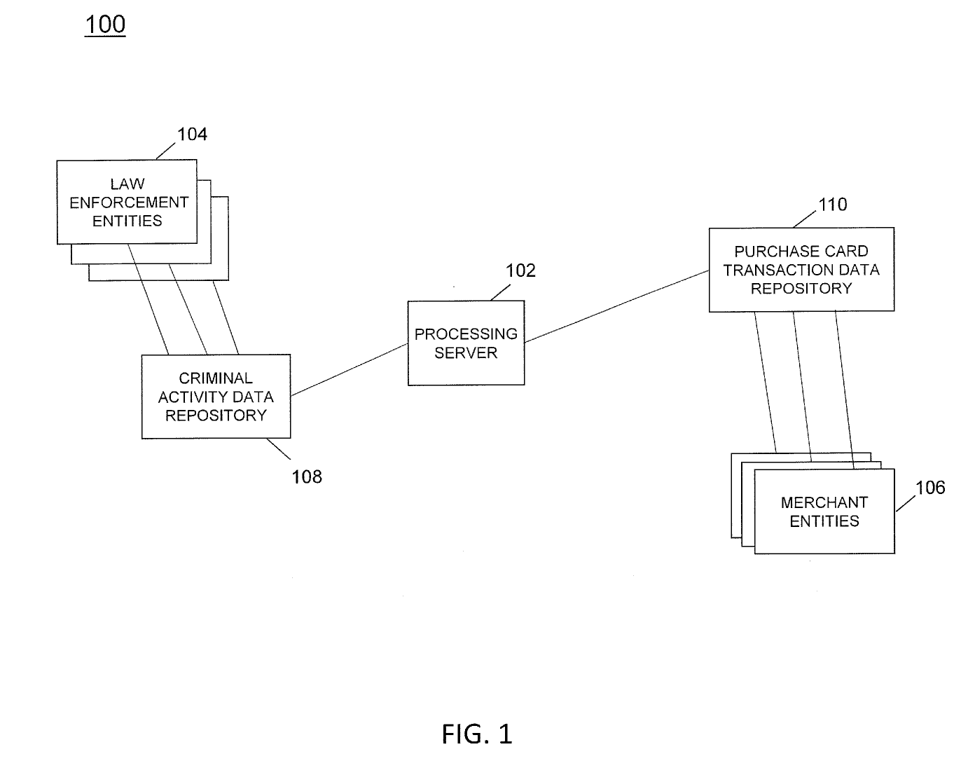

FIG. 1 illustrates an exemplary system 100 for determining criminal propensities in a geographic location based on purchase card transaction data according to an embodiment of the subject matter described herein. For example, system 100 may include a processing server 102, a plurality of law enforcement entities 104, a plurality of merchant entities 106, a criminal activity data repository 108, and a purchase card transaction data repository 110.

In some embodiments, each of law enforcement entities 104 may include a server computer that is utilized by a regional law enforcement agency (e.g., a city police department, a county sheriff office, a state police department, etc.) for the purposes of recording, managing, processing, and storing criminal activity records associated with unlawful activities committed in a particular law enforcement agency's jurisdiction. Although not shown, each law enforcement entity server may include a central processing unit and memory configured to execute a software based program and/or module. Exemplary criminal activity record data can include information pertaining to the type of criminal offense committed, the location of the criminal offense committed, and the date and time in which the criminal offense was committed. For example, the type of criminal offense may be classified in accordance to specific crimes (e.g., theft, pickpocketing, robbery, burglary, criminal assault, kidnapping, fraud, sale of illegal substances, etc.). Similarly, the location of the crime committed may be classified in accordance with a zip code (e.g., a five digit zip code or a nine digit zip+4 level code), a police precinct area, county, area code, or any other regional classification.

In some embodiments, the criminal activity record data generated by law enforcement entities 104 is ultimately provided to criminal activity data repository 108 for storage and compilation. Notably, the criminal activity record data may be supplied by law enforcement entities 104 on a periodic basis (e.g., daily, weekly, monthly, etc.) or at the discretion of the system administrator operating/managing the law enforcement server. In some embodiments, criminal activity data repository 108 may include one or more host servers configured to function as a centralized repository or database (e.g., CompStat). In other embodiments, criminal activity data repository 108 may instead include a distributed network of criminal activity databases associated with various geographic locations.

As indicated above, system 100 may also include a plurality of merchant entities 106. In some embodiments, each of merchant entities 106 may represent one or more computer servers that are utilized by a merchant entity (e.g., a merchant company, a corporation, etc.) to record, compile, manage, process, and store purchase card transaction data corresponding to purchase card transactions conducted at any of the merchant entity's store locations. In some embodiments, each of merchant entities 106 may represent computer servers, each of which is operated by and/or associated with a separate company entity (e.g., a different company, corporation, or seller). Likewise, merchant entities 106 may also represent computer servers servicing and/or located at different merchant locations associated with a common merchant entity (e.g., at separate store locations of the same company or corporation). In some embodiments, a merchant entity 106 may also include a terminal device (e.g., a cash register, a credit card reader, a wireless device reader, etc.) that can be located and utilized at a particular point of sale (PoS) location associated with the merchant entity. Regardless of the type of device, each of merchant entities 106 can be configured to supply purchase card transaction data to purchase card transaction data repository 110 on a periodic basis or at the discretion of a system administrator.

In some embodiments, purchase card transaction data repository 110 may include one or more computer servers hosting databases configured for storing processed consumer-merchant transaction data reports (e.g., actual purchase card transaction data associated with a consumer) that is obtained from one or more of merchant entities 106.

In some embodiments, each purchase card transaction data report may include account numbers identifying the consumer (e.g., a credit card holder, debit card holder, and/or prepaid card holder) conducting the transaction as well as other purchase card transaction information, such as a purchase card transaction location (e.g., address and/or zip code), a purchase card transaction date and time, a purchase card transaction amount, a merchant/seller identifier, a purchase card transaction category (e.g., an industry classification of the merchant/seller), and the like. In one embodiment, purchase card transaction data repository 110 may include a computer server hosting a MasterCard (MC) purchase card transaction database that records the purchase card transactions conducted by MasterCard credit card, debit card, corporate card, or prepaid card users at merchant locations. However, the disclosed subject matter is not limited to the use of MC purchase card transaction data, and thus purchase card transaction data and/or consumer card transaction information from other sources may be utilized without departing from the scope of the present subject matter.

System 100 further includes a processing server 102 that is communicatively connected to both purchase card transaction data repository 110 and criminal activity data repository 108. Notably, processing server 102 can be configured to obtain purchase card transaction records and criminal activity records from purchase card transaction data repository 110 and criminal activity repository 108, respectively. In some embodiments, processing server 102 may be configured to send a query message in order to request information from each of repositories 108-110. Alternatively, repositories 108-110 may be configured to periodically send data to processing server 102 without any prompting (e.g., a reply message and/or data provisioning message in response to a query message sent by processing server 102).

Upon receiving the purchase card transaction record data and criminal activity record data from repositories 108-110, processing server 102 may be configured to index the purchase card transaction data, correlate the indexed data with the criminal activity data records, and generate an algorithmic model based on the correlated data. Examples of the indexing, correlating, and generating processes are described below in greater detail.

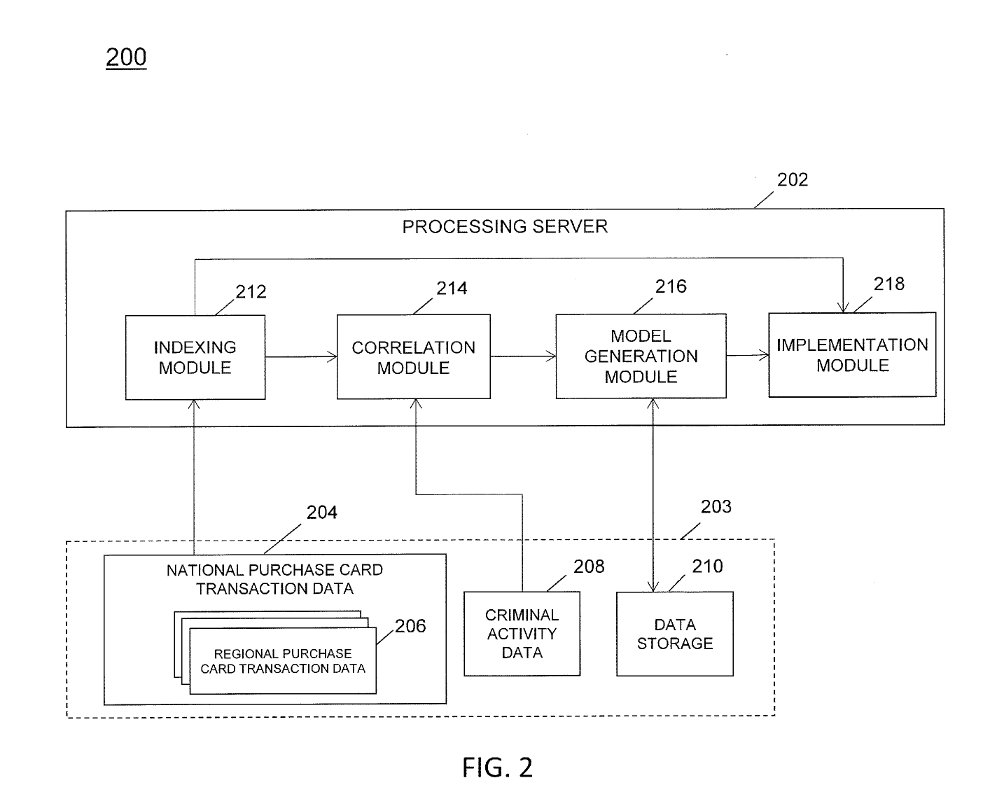

FIG. 2 illustrates an exemplary system 200 which is configured to utilize purchase card transaction data to determine the criminal propensities of a particular geographic region. System 200 may include a processing server or system 202 and a plurality of data repositories 204, 208, and 210. In one embodiment, processing server 202 is not unlike processing server 102 depicted in FIG. 1. In some embodiments, system 202 may include a single data warehouse 203 that is configured to host the aforementioned data repositories 204, 208, and 210 at a single centralized location. For example, data warehouse 203 may include national purchase card transaction data repository 204, a criminal activity data repository 208, and a data storage unit 210. Each of these data repositories or data warehouses is described below in greater detail. Alternatively, data warehouse 203 may instead depict a logical representation of a grouping of repositories 204, 208, and 210. In some embodiments, system 200 may be implemented using conventional computer hardware, processing units, and application software configurations including, for example, distributed server systems. System 200 also may include other conventional hardware and software components that are not shown in FIG. 2, such as user terminals and data warehouse query tools.

In some embodiments, data warehouse 203 may include a national purchase card transaction data repository 204 that hosts at least one regional purchase card transaction database 206. Namely, although FIG. 2 depicts national purchase card transaction data repository 204 hosting one or more regional purchase card transaction database 206, purchase card transaction data may be organized and/or hosted by national purchase card transaction data repository 204 in any manner or number of databases without departing from the scope of the disclosed subject matter. In some embodiments, national purchase card transaction data repository 204 may include one or more databases configured for storing processed consumer-merchant transaction data reports corresponding to purchase card transactions conducted all over the country. Notably, the data stored by national purchase card transaction data repository 204 can be used to compile and store customer card transaction data records that detail expenditure amounts in each of a plurality of industry categories at a national level. Exemplary industry categories include, but are not limited to, restaurant dining, groceries, leisure, entertainment, gas, department stores, and the like. In some embodiments, national purchase card transaction data repository 204 may also include cross border expenditure spend amounts. For example, the national purchase card transaction data may be classified and compiled in accordance with national cities or areas that experience high volumes of visiting tourists or nationals from other foreign countries.

Similarly, each regional purchase card transaction database 206 may include the aforementioned customer card transaction data records hosted by national purchase card transaction data repository 204, but arranged/organized with respect to a particular geographic location (e.g., state, county, city, zip code area, zip+4 area, police precinct, area code, etc.). For example, national purchase card transaction data repository 204 may be organized in such a manner that a specific memory location (e.g., represented by database 206) may be allocated/designated for customer card transaction data records associated with a specific geographic location or region.

In some embodiments, each customer card transaction data record stored in repository 204 (and/or database(s) 206) may include a purchase card transaction location, purchase card transaction amount, a merchant/seller identifier, a purchase card transaction industry category, and a purchase card transaction time and date. Notably, account numbers and subscriber names are not necessary for the purposes of the disclosed subject matter and may be omitted from the records stored by repository 204. In some embodiments, repository 204 may include a MasterCard (MC) purchase card transaction data repository that records the purchase card transactions conducted by MasterCard credit card, debit card, or prepaid card users.

Criminal activity data repository 208 may include or more databases configured for storing criminal activity data records. In some embodiments, criminal activity data repository 208 (not unlike criminal activity data repository 108 depicted in FIG. 1) may include a centralized computer server that hosts databases configured to store criminal offense type data that is periodically provisioned by various law enforcement entities. The criminal offense type data may be stored as criminal activity data records that include, but not limited to, a criminal offense type (e.g., burglary, robbery, theft, etc.), a criminal offense location (e.g., state, county, city, zip code area, zip+4 area, police precinct, area code, etc.), and/or a criminal offense date and time. Notably, the identity of an accused culprit and/or convicted criminal is not needed for the purposes of the disclosed subject matter.

FIG. 2 further depicts processing server 202 as a single entity that contains a plurality of data processing modules, such as an indexing module 212, a correlation module 214, a model generation module 216, and an implementation module 218. In some embodiments, processing server 202 may include any server, node, or unit that is configured to process purchase card transaction data (e.g., consumer card transaction data) to generate and determine the criminal propensity of a geographic location via the methods described herein. Although FIG. 2 depicts processing sever 202 as a single network element, processing server 202 may include a plurality of network elements, a plurality of network components, and/or a network itself without departing from the scope of the disclosed subject matter. For example, in an alternate embodiment, each of the aforementioned data processing modules may be respectively hosted by its own computer server and said plurality of host computer servers may form a processing system 202. In some embodiments, processing server 202 may include a processor (not shown), such as a microprocessor, central processing unit (CPU), or any other like hardware based processor unit that is configured to execute and/or utilize the modules in processing server 202. Each of the depicted modules in processing server 202 may be stored in local memory (not shown), such as random access memory (RAM), read only memory (ROM), optical read/write memory, cache memory, magnetic read/write memory, flash memory, and the like.

In some embodiments, indexing module 212 may be configured to obtain and/or receive purchase card transaction data (e.g., purchase card transaction data records or files) from national purchase card transaction data repository 204 (e.g., from a general national database and/or regional purchase card transaction database 206). For example, indexing module 212 may query repository 204 for both national purchase card transaction data (e.g., maintained in a general database (not shown) in repository 204) and for regional purchase card transaction data that is linked to a specific geographic location, region, or area (e.g., stored specifically in database 206). In some embodiments, indexing module 212 may utilize common date and time information and/or industry category information contained in the purchase card transaction data records to index or “normalize” the regional purchase card transaction data. For example, indexing module 212 may be configured to index the regional purchase card transaction data in such a manner that a plurality of first regional expenditure indices for each of a plurality of industry categories (and/or specific merchant sellers) for a given time period can be determined. In some examples, indexing module 212 may index purchase card transaction records (e.g., consumer card transaction records) that detail purchase card transactions that have been conducted in the last 30 days into separate and distinct industry categories (e.g., a restaurant dining category, an entertainment category, a groceries category, etc.). After indexing the transaction records into their respective industry categories, indexing module 212 may determine the sum total of the purchase card expenditure in said categories for the particular location or region (e.g., regional expenditure amounts). For example, indexing module 212 may determine that 8 million dollars were spent in dining (i.e., restaurant dining category) in a first region or location (e.g., zip code 88899). In some embodiments, indexing module 212 may process data that is organized in a “spend per capita”, or “expenditure per capita”, format. For example, indexing module 212 may determine that the expenditure capita for restaurant dining in the first region or location (e.g., zip code 88899) is $80 per person. In some embodiments, national purchase card transaction data repository 204 may be configured to provide regional purchase card transaction data and/or national purchase card transaction data in an expenditure per capita format to indexing module 212. Alternatively, indexing module 212 may be configured to convert the purchase card transaction data received from national purchase card transaction data repository 204 into an expenditure per capita format (e.g., in the event indexing module has access or is provided with relevant population data).

Indexing module 212 may be further configured to use the national purchase card transaction data to determine national levels and/or averages of purchase card expenditure for each of the plurality of industry categories (and/or specific merchant sellers) in the same manner as the regional expenditure indices. In some embodiments, indexing module 212 may be configured to index purchase card transaction records (e.g., consumer card transaction records) that have been generated in the last 30 days into the same industry categories indicated above and to subsequently determine an average total of the purchase card expenditure in said categories across the nation (e.g., national average expenditure amounts). Notably, the indexing module 212 may consider factors such as population (e.g., per capita) or square miles to determine the aforementioned “average” national purchase card expenditure index for a particular industry category. In some embodiments, the determination of the national average purchase card expenditure may comprise the overall expenditure amounts for each industry category (or specific merchant seller). For example, indexing module 212 may determine that 10 million dollars was spent on average for restaurant dining at a national level during the designated 30 day period. In another example, indexing module 212 may determine that the national average expenditure per capita for restaurant dining during the 30 day period is equal to $100 per person.

After calculating both the regional expenditure amount and the national expenditure amount for a particular industry category (e.g., restaurant dining), indexing module 212 may be configured to generate a normalized regional expenditure index for the first geographic region (e.g., zip code 88899). In some embodiments, the normalized regional expenditure index for an industry category may be determined by dividing the regional expenditure amount by the previously determined national average expenditure amount (e.g., 8 million dollars divided by 10 million dollars or alternatively, $80/person divided $100/person) to generate a normalized index value of 0.80. Notably, indexing module 212 may generate a normalized regional expenditure index for each separate industry category. After one or more normalized regional expenditure indices are generated, indexing module 212 may forward said normalized regional expenditure indices to correlation module 214.

In some embodiments, correlation module 214 may receive, in addition to the normalized regional expenditure indices, criminal activity record data from criminal activity data repository 208. In some embodiments, correlation module 214 may correlate each of the normalized regional expenditure indices generated by indexing module 212 with criminal activity record data obtained from criminal activity data repository 208 via the use of common parameters or variables that are associated with both types of data. For example, correlation module 214 may identify (or request) criminal activity data records that include by i) the same date and time period (e.g., last 30 days) and ii) the same geographic location (e.g., zip code 88899) associated with the normalized regional expenditure indices. In some embodiments, correlation module 214 may generate a correlation between the normalized regional expenditure index for each industry category with a particular criminal offense type. For example, the “0.80” normalized regional expenditure index for restaurant dining in zip code 88899 may be correlated with robbery data (e.g., 50 robberies in zip code 88899 in the last 30 days) obtained from repository 208. Thus, the correlation may comprise a ratio of [0.80:50]. Moreover, correlation module 214 may establish additional correlations using the normalized regional expenditure index (e.g., 0.80 index) for restaurant dining with each criminal offense type (e.g., theft, burglary, sale of illegal substances, etc.). Similarly, correlation module 214 may establish other correlations by correlating the normalized regional expenditure indices associated with the other industry categories (e.g., groceries, entertainment, etc.) with each of the different criminal offense types.

After being generated by correlation module 214, the plurality of correlations may be provided to model generation module 216. Upon receiving the one or more established correlations, module generation module 216 may be configured to generate the algorithmic model. In some embodiments, an analytic platform including a logistic regression function tool may be utilized to generate or empirically develop the algorithmic model. In some embodiments, correlation module 214 may be configured to derive a duration-based correlation (i.e., time series aspect) between the normalized regional expenditure index and the criminal activity data in the designated location. For example, correlation module 214 may have access to (e.g., provided by repositories 204 and 208) 36 months of historical index data and 36 months of criminal activity data that can be utilized to ascertain if the historical index data and historical criminal activity data reveal a specific crime pattern in the same 36 months in the same designated location (e.g., zip code area).

Once created, the algorithmic model may be provided to implementation module 218 from model generation module 216. In some embodiments, implementation module 218 may apply the algorithmic model to a plurality of second normalized regional expenditure indices associated with a second geographic location. For example, processing server 202 may receive a request for a criminal propensity indicator associated with a second geographic location (e.g., zip code 39988) from a requesting entity (e.g., a system administrator). In some embodiments, the second geographic location may be characterized as an area or region with limited access to local criminal activity data. Consequently, indexing module 212 may be configured to obtain customer card transaction data corresponding to purchase card transactions made in the second geographic location in the past 30 days (i.e., same time period from which the aforementioned algorithmic model is generated) from an appropriate regional purchase card transaction database 206. Indexing module 212 may then normalize the second regional expenditure amounts for each of the same industry categories in the same manner described above. For example, the second normalized regional expenditure index for restaurant dining may be determined to be 0.50 (based on a 4 million dollar restaurant dining regional expenditure amount divided by the previously determined 8 million dollar national expenditure average). Similarly, the second normalized regional expenditure index for restaurant dining may be determined to be 0.50 if the expenditure per capita amounted to $50 per person. Once the normalized regional expenditure indices for the second geographical location are determined for the various industry categories, the determined normalized indices are provided to implementation module 218.

In response, implementation module 218 may apply the algorithmic model to the plurality of second normalized regional expenditure indices corresponding to the second geographic location. In some embodiments, the implementation module 218 may divide a second normalized regional expenditure index (e.g., 0.50) associated with restaurant dining by the previously determined correlation ratio [0.80:50] included in the algorithmic model (e.g., [0.50/(0.80:50)]). Notably, this example calculation produces a criminal propensity indicator value of 31.25, which may represent or be used to determine the number of probable robberies committed in the second geographic region over the predefined time period of 30 days. The algorithmic model may also utilize the index for the second geographic location and the other determined normalized ratios associated with other criminal offense types to predict the propensity for different criminal activities in the second geographic region.

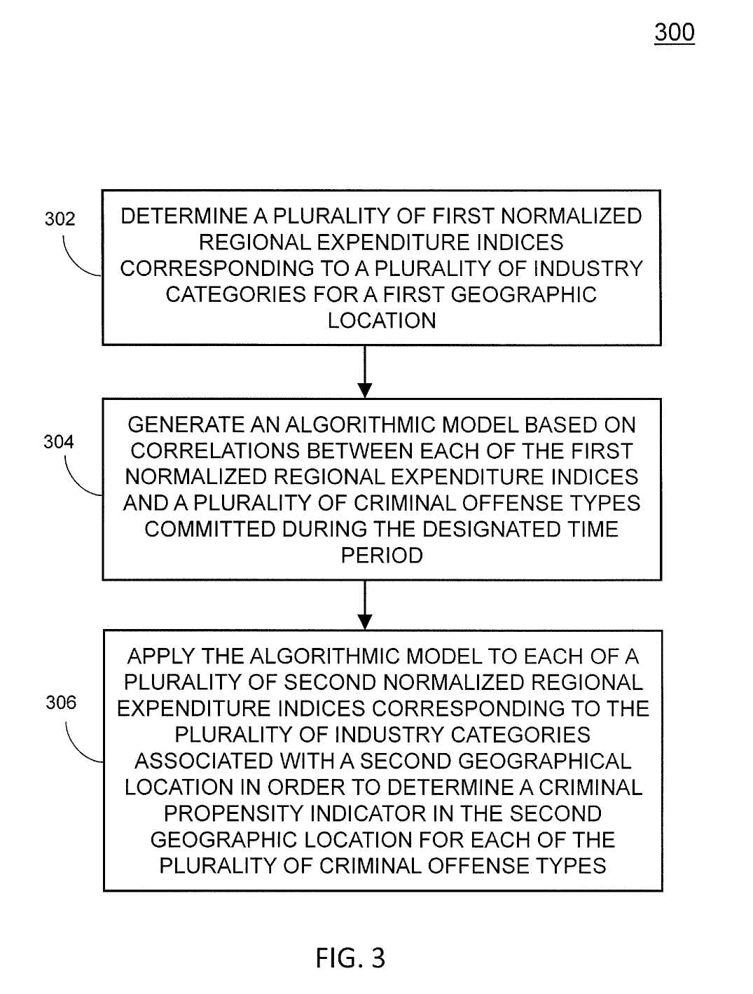

FIG. 3 is a flow chart illustrating an exemplary method 300 for determining the likelihood of criminal propensities in a geographic location based on purchase card transaction data according to an embodiment of the subject matter described herein. Although exemplary method 300 utilizes consumer card transaction data, any type of purchase card transaction data may be utilized without departing from the scope of the present subject matter. In step 302, a plurality of first normalized regional expenditure indices corresponding to a plurality of industry categories for a first geographic location is determined. In some embodiments, a national consumer card transaction expenditure average in each of the plurality of industry categories may initially be determined. Similarly, consumer card transaction data representing consumer card transactions conducted in a first geographic location/region may be utilized to determine a plurality of first regional expenditure indices for each, of the industry categories. For example, a processing server may determine that, for the past 30 days, the amount of the regional expenditure per capita in restaurant dining activities totals $80 per person. The processing server may then be configured to determine a plurality of first normalized regional expenditure indices by indexing (e.g., benchmarking) each of the plurality of first regional expenditure indices to the national consumer card transaction expenditure average. In one embodiment, the indexing may entail dividing the restaurant dining regional expenditure index by the national expenditure average over the same time period (i.e., last 30 days). For example, if the national expenditure average equaled $100 per person, the resulting index would be equal to 0.80.

In step 304, an algorithmic model based on correlations between each of the first normalized regional expenditure indices and a plurality of criminal offense types committed during the designated time period is generated. In some embodiments, the algorithmic model may include a plurality of correlation, wherein each correlation includes a ratio between a first normalized regional expenditure index for one of the different industry categories and a criminal offense type. For example, the algorithmic model may utilize the determined normalized restaurant dining expenditure index determined in step 302 for a particular geographic location and correlate the value to a criminal offense type committed in the same geographic location and during the same time period (as the determined normalized expenditure index). In this example, the algorithmic model may utilize information that indicates that there have been 50 instances of robbery (i.e., a specific criminal offense type) in the same geographic location and during same time period defined in step 302. Accordingly, the processing server may generate an algorithmic model that correlates, for the designated geographic location, a normalized restaurant dining expenditure index of 0.80 to the 50 reported robbery offenses to derive a ratio model parameter of [0.80:50]. The normalized restaurant dining expenditure index of 0.80 can also be applied to other criminal offense types, such as theft (e.g., pickpocketing), burglary, fraud, kidnapping, sale of illegal substances, and the like. Moreover, other normalized expenditure indices associated with various industry categories (e.g., groceries, gas, entertainment, leisure, department stores, etc.) may be similarly applied to the aforementioned criminal offense types.

In step 306, the algorithmic model is applied to each of a plurality of second normalized regional expenditure indices corresponding to the plurality of industry categories associated with a second geographic location in order to determine a criminal propensity indicator in the second geographic location for each of the plurality of criminal offense types. In some embodiments, the algorithmic model derived in step 304 may comprise a plurality of ratios that can be utilized to determine predict the criminal propensity of another geographic location upon input of customer card transaction data associated with a second geographic location. For example, a plurality of second normalized regional expenditure indices corresponding to the same aforementioned industry categories is initially determined. For example, the processing server may determine that, for the past 30 days, the regional expenditure index for restaurant dining in the second geographic location amounts to $50 of restaurant dining expenditure per capita. The processing server may then be configured to determine a second normalized regional expenditure index by indexing the expenditure index to the aforementioned national consumer card transaction expenditure average. For example, the indexing may include dividing the $50 per capita restaurant dining regional expenditure by the $100 per capita national expenditure average (over the same 30 day time period). In such a scenario, the resulting index would be equal to 0.50.

Once the index for the second geographic location is determined, the processing server may apply the algorithmic model to the determined index or indices in order to determine one or more criminal propensity indicators for the second geographic location. For example, the processing server may be configured to apply the normalized ratio (as determined by steps 302 and 304) of the first geographic location to the index of the second geographic location. In one embodiment, the index may be divided by the normalized ratio (e.g., [0.50/(0.80:50)]). Notably, this exemplary calculation produces a criminal propensity indicator value of 31.25, which may represent or be used to determine the number of probable robberies committed in the second geographic region over the predefined time period of 30 days. In addition to determining a criminal propensity indicator value, one may assume that if the normalized regional expenditure index of 0.80 is highly correlated to a robbery offense in the 88899 zip code area during the last 30 days, the presumption that any other geographical location (e.g., zip code area) with the same level of expenditure per capita may have a similar pattern or likelihood for robbery may be made. In some embodiments, indices associated with each of the different industry categories may also be utilized (e.g., as illustrated with duration based charts and/or time series chart plots) to reinforce the correlation. The algorithmic model may also utilize the index for the second geographic location and the other determined normalized ratios associated with other criminal offense types to predict the propensity for different criminal activities in the second geographic region.

It will be understood that various details of the subject matter described herein may be changed without departing from the scope of the subject matter described herein. Furthermore, the foregoing description is for the purpose of illustration only, and not for the purpose of limitation.

What is claimed is:

1. A method for determining criminal propensities in a geographic location based on purchase card transaction data, the method comprising:
utilizing purchase card transaction data associated with purchase card transactions conducted during a designated time period to determine a plurality of first normalized regional expenditure indices corresponding to a plurality of industry categories for a first geographic location;
generating an algorithmic model based on correlations between each of the first normalized regional expenditure indices and a plurality of criminal offense types committed during the designated time period; and
applying the algorithmic model to each of a plurality of second normalized regional expenditure indices corresponding to the plurality of industry categories associated with a second geographic location in order to determine a criminal propensity indicator in the second geographic location for each of the plurality of criminal offense types.

2. The method of claim 1 wherein utilizing the purchase card transaction data includes determining a national consumer card transaction expenditure average in each of the plurality of industry categories, utilizing the purchase card transaction data to determine a plurality of first regional expenditure indices for each of the plurality of industry categories, and determining the plurality of first normalized regional expenditure indices by indexing the plurality of first regional expenditure indices to the national consumer card transaction expenditure average.

3. The method of claim 1 wherein the purchase card transaction data is obtained from a credit card data repository.

4. The method of claim 3 wherein the purchase card transaction data comprises transaction data records including at least one of a purchase card transaction location, a purchase card transaction time, a purchase card transaction amount, and a purchase card transaction category.

5. The method of claim 4 wherein criminal activity data corresponding to the criminal offense types is obtained from a criminal offense data repository.

6. The method of claim 5 wherein the criminal activity data includes at least one of a criminal offense type, a criminal offense location, and a criminal offense time.

7. The method of claim 6 wherein generating the algorithmic model includes correlating i) the purchase card transaction time and the criminal offense time and ii) the purchase card transaction location and the criminal offense location.

8. The method of claim 1 wherein each of the first geographic location and the second geographic location is defined by at least a portion of the zip code.

9. The method of claim 1 wherein the national consumer card transaction expenditure average comprises a cross border consumer card transaction expenditure average.

10. A system for determining criminal propensities in a geographic location based on purchase card transaction data, the system comprising:
a criminal offense data repository configured to store criminal activity data;
a purchase card transaction data repository configured to store purchase card transaction data; and
a processing server configured to:
obtain, from the purchase card transaction data repository, purchase card transaction data associated with purchase card transactions conducted during a designated time period to determine a plurality of first normalized regional expenditure indices corresponding to a plurality of industry categories for a first geographic location,
generate an algorithmic model based on correlations between each of the first normalized regional expenditure indices and a plurality of criminal offense types committed during the designated time period, wherein the plurality of criminal offense types is included in the criminal activity data obtained from the criminal offense data repository, and
apply the algorithmic model to each of a plurality of second normalized regional expenditure indices corresponding to the plurality of industry categories associated with a second geographic location in order to determine a criminal propensity indicator in the second geographic location for each of the plurality of criminal offense types.

11. The system of claim 10 wherein the processing server is further configured to determine a national consumer card transaction expenditure average in each of the plurality of industry categories, utilize the purchase card transaction data to determine a plurality of first regional expenditure indices for each of the plurality of industry categories, and determine the plurality of first normalized regional expenditure indices by indexing the plurality of first regional expenditure indices to the national consumer card transaction expenditure average.

12. The system of claim 10 wherein the purchase card transaction data is obtained from a credit card data repository.

13. The system of claim 12 wherein the purchase card transaction data comprises transaction data records including at least one of a purchase card transaction location, a purchase card transaction time, a purchase card transaction amount, and a purchase card transaction category.

14. The system of claim 13 wherein criminal activity data corresponding to the criminal offense types is obtained from a criminal offense data repository.

15. The system of claim 14 wherein the criminal activity data includes at least one of a criminal offense type, a criminal offense location, and a criminal offense time.

16. The system of claim 15 wherein the processing server is further configured to correlate i) the purchase card transaction time and the criminal offense time and ii) the purchase card transaction location and the criminal offense location.

17. The system of claim 10 wherein each of the first geographic location and the second geographic location is defined by at least a portion of the zip code.

18. The system of claim 10 wherein the national consumer card transaction expenditure average comprises a cross border consumer card transaction expenditure average.

19. A non-transitory computer readable medium having stored thereon executable instructions for controlling a computer to perform steps comprising:
utilizing purchase card transaction data associated with purchase card transactions conducted during a designated time period to determine a plurality of first normalized regional expenditure indices corresponding to a plurality of industry categories for a first geographic location;
generating an algorithmic model based on correlations between each of the first normalized regional expenditure indices and a plurality of criminal offense types committed during the designated time period; and
applying the algorithmic model to each of a plurality of second normalized regional expenditure indices corresponding to the plurality of industry categories associated with a second geographic location in order to determine a criminal propensity indicator in the second geographic location for each of the plurality of criminal offense types.

20. The computer readable medium of claim 19 wherein the processing server is further configured to determine a national consumer card transaction expenditure average in each of the plurality of industry categories, utilize the purchase card transaction data to determine a plurality of first regional expenditure indices for each of the plurality of industry categories, and determine the plurality of first normalized regional expenditure indices by indexing the plurality of first regional expenditure indices to the national consumer card transaction expenditure average.
